(19) United States
(12) Patent Application Publication
(10) Pub. No.: US 2007/0205963 A1
(43) Pub. Date: Sep. 6, 2007

(54) Heads-up billboard

(76) Inventors: Gregory A. Piccionelli, Westlake Village, CA (US); Michael M. Gerardi, Menifee, CA (US)

Correspondence Address: Michael M. Gerardi, 28876 WoodcresttLake Drive, Menifee, CA, 92584, US

(21) Appl. No.: 11/368,348

(22) Filed: Mar. 3, 2006

(51) Int. Cl. G09G 5/00

(52) U.S. Cl. 345/7

(57) ABSTRACT

A method of providing visual information to a human viewer includes the steps of defining a range of distances from a surface and a range of viewing angles with respect to the surface, determining the location and viewing angle of a human viewer with respect to the surface, and providing a virtual image to the human viewer via a visual display device worn by the human viewer when the location and viewing angle of the human viewer with respect to the surface is determined to be within the defined range of distances and viewing angles, such that the virtual image is perceived to be defined on the surface by the human viewer.

### FIELD OF THE INVENTION

The present invention relates to methods and systems of providing information, more particularly visual information, to a human viewer. More specifically, the present invention relates to methods of providing a virtual image to a human viewer when the human viewer views and object, such as a billboard or a wall of a building, on which a blank surface is defined.

### BACKGROUND OF THE INVENTION

Visual information, for example commercial information pertaining to new products and services, sales events, entertainment and the like, is provided to potential customers in various manners. Effective formats include outdoor advertising, in which the visual information is posted on a large surface, such as a billboard or a wall of a building, and is viewable by the general public. Outdoor advertising is relatively inexpensive, but is not readily alterable.

Electronic billboards and other animated displays are also effective in providing visual information to large numbers of potential customers. However, such displays are relatively expensive and are not easily transported or mounted on a variety of surfaces.

A need exists for a method of providing visual information to a human viewer that is inexpensive and flexible, and that is adaptable for use with a wide range of surfaces and display areas. A need also exists for a method that can provide targeted visual information to individual viewers. A need also exists for systems for implementing such methods.

### SUMMARY OF THE PREFERRED EMBODIMENTS

In accordance with one aspect of the present invention, there is provided a method of providing visual information to a human viewer. The method includes the steps of: defining a range of distances from a surface and a range of viewing angles with respect to the surface; determining the location and viewing angle of a human viewer with respect to the surface; and providing a virtual image to the human viewer via a visual display device (e.g., a heads-up display) worn by the human viewer when the location and viewing angle of the human viewer with respect to the surface is determined to be within the selected range of distances and viewing angles, such that the virtual image is perceived to be defined on the surface by the human viewer.

According to more specific embodiments, the surface is a billboard, a wall, a static display or a hand-held item, more particularly a book, a magazine, a newspaper or a menu. At least a portion of the surface is blank, in particular embodiments, or a blue surface, in other particular embodiments.

The location and viewing angle of the human viewer with respect to the surface are determined using the GPS coordinates of the human viewer and the surface in particular embodiments.

Virtual images provided to the human viewer according to embodiments of the inventive method include advertisements, menus and public notices.

Organizations can practice methods according to the present invention in order to provide selected visual information to target human viewers; by the same token, human viewers who are members of such organizations can select goods and services for which they desire to receive visual information, and can further specify the advertisement format(s) in which they desire to receive the information, e.g., information comprising text, still and/or video images (including images of human models) and combinations thereof. According to related embodiments, the human viewer can select at least one event, such as a sale, for which the human viewer requests the provision of a virtual image.

Virtual images can be accompanied by an audio stream, such as a verbal advisory, in more specific embodiments of the inventive method. According to still other particular embodiments, the human viewer is provided with a premium when the virtual image is viewed.

The surfaces upon which the virtual image appears to be defined is not restricted to fixed or immobile surfaces such as billboards. According to other particular embodiments, the surface includes article of clothing, such as a costume or mask, worn by a human performer. The virtual images so defined can be, for example, images of a costume other than that worn by the performer, or images of human faces.

In accordance with another aspect of the present invention, there is provided a method of receiving visual information from a provider, the visual information being transmitted to a human viewer as a virtual image, the human viewer wearing a visual display device enabling viewing of a virtual image. The method includes the steps of: providing the location of a human viewer to a central site with which a provider is associated; determining the distance and the viewing angle between the human viewer and a surface associated with the provider; and receiving a virtual image from the provider via a visual display device worn by the human viewer enabling viewing of the virtual image when the distance and viewing angle between the human viewer and the surface is determined to be within a range of distances and viewing angles specified by the provider.

In more specific embodiments, the human viewer is a member of an organization and the central site is associated with the organization. Such embodiments afford the human user the opportunity to select goods, services, advertisement formats and events for which the visual information is to be provided.

In accordance with a further aspect of the present invention, there is provided a system for providing visual information to a human viewer. The system includes: means for determining the location and viewing angle of a human viewer with respect to a surface; a visual display device worn by the human viewer; and means for providing a virtual image to the human viewer via the visual display device when the location and viewing angle of the human viewer with respect to the surface is determined to be within a preselected range of distances and viewing angles with respect to the surface, such that the virtual image is perceived to be defined on the surface by the human viewer.

The foregoing embodiments calculate a viewing angle of the human viewer with respect to the surface. Alternate embodiments replace angle calculations with active sensing of the surface (for example, by use of an infrared ranging device, a radar device or the like) in order to determine the distance between the human viewer and the surface and the orientation of the human viewer with respect to the surface.

Other features and advantages of the present invention will become apparent to those skilled in the art from the following detailed description. It is to be understood, however, that the detailed description and specific examples, while indicating preferred embodiments of the present invention, are given by way of illustration and not limitation. Many changes and modifications within the scope of the present invention may be made without departing from the spirit thereof, and the invention includes all such modifications.

### BRIEF DESCRIPTION OF THE DRAWINGS

The invention may be more readily understood by referring to the accompanying drawings in which FIGS. 1a-3c illustrate a first embodiment of a method according to the invention in which a human viewer in a vehicle moving with respect to a billboard is provided with visual information. FIGS. 1a, 2a and 3a depict the location of the vehicle with respect to a selected maximum distance Rₘ and maximum viewing angle θₘ. FIGS. 1b, 2b and 3b illustrate the appearance of the billboard as perceived by the human viewer. FIGS. 1c, 2c and 3c illustrate the projection of the visual information on a device (as shown, a heads-up display) worn by the human viewer.

FIGS. 4a-6b illustrate a second embodiment of a method according to the invention in which a human viewer on foot passes by a place-of business having a wall with a blank portion. FIGS. 4a, 5a and 6a depict the location of the human viewer with respect to a selected maximum distance Rₘ and maximum viewing angle θₘ. FIGS. 4b, 5b and 6b illustrate the appearance of the portion of the wall as perceived by the human viewer.

FIGS. 7a-c illustrate a third embodiment of a method according to the invention in which a plurality of human viewers (as shown, two viewers) both view a blank portion of a wall of a business while within the selected range of distances and viewing angles. Each viewer is provided with personalized visual information in accordance with the viewer's selection criteria.

FIGS. 8a-9b illustrate a system for providing visual information to a human viewer viewing an item adapted to be held by the human viewer (as shown, a magazine). The magazine includes at least one page having a blank surface defined on at least a portion thereof. The human viewer perceives a virtual image projected on the blank surface via a visual display device worn by the human viewer.

In the figures, like elements are numbered alike throughout.

### DETAILED DESCRIPTION OF THE PREFERRED EMBODIMENTS

According to embodiments of the present invention, any blank or blue-screen surface can be used to provide visual information to a human viewer using a heads-up display unit which preferably is worn by the human viewer. Thus, billboards, walls, static displays, and even mobile surfaces such as the sides of moving vehicles, e.g., truck trailers, and the costumes of performers can be used as surfaces upon which virtual images appear to the human viewer.

A human viewer is equipped with an appropriate visual display device, typically a heads-up display (HUD) device, which the viewer wears while driving, walking, etc. The human viewer's location typically is determined by GPS means, which can be incorporated into the visual display device or, alternatively, can be separately worn by the human viewer or otherwise associated with the human viewer (for example, located within the human viewer's car). Other means of determining the human viewer's location, such as short-range radio transmissions which identify the individual human viewer and convey information on the viewer's interests and preferences, can also be used, and use of such means is contemplated as being within the scope of the present invention. The human viewer's location (e.g., GPS coordinates) are provided to a central site maintained by an organization, typically by wireless transmission means.

The location of at least one surface to be utilized according to methods of the invention is also provided to the central site. For example, the GPS coordinates of a billboard, a portion of a wall of a store, restaurant or other commercial establishment, a static display within a shopping mall, etc., are provided to the central site. Moving objects, such as truck trailers, or moving performers wearing blank or blue costumes, typically are equipped with GPS means and provide continually updated GPS coordinates to the central site. The location is typically provided by the owner of the billboard, commercial establishment, etc., or by the performer, the employer of the performer, the owner or driver of the truck to which the trailer is coupled, etc. In addition to the location of the surface, a range of distances and viewing angles is also provided in more particular embodiments. The range of distances can vary, for example, from zero to 300 feet; the viewing angle can vary, for example, from zero to 60 degrees.

In specific embodiments, the organization that maintains the central site requires provision of a premium, such as a cash payment, a deposit to a credit account, or the like, prior to accepting the location information so provided. In other specific embodiments, the organization provides a premium to the owner of the surface; such embodiments are beneficial when a third party desires to provide visual information to a human viewer using a surface not owned by the third party.

Once provided with the location of the surface(s), the central site tracks the location of the human viewer, and also determines the relative distance and direction from the location of the human viewer to the location provided for the surface(s). When it is determined that the human viewer's location with respect to a surface is within the specified range of distances and viewing angles, the viewer is then provided with visual information via the visual display device being worn by the human viewer.

Turning now to the figures, FIGS. 1a-3c illustrate a first embodiment of a method according to the invention. In FIG. 1a, a billboard 10 is located adjacent a highway. A range of distances (as shown, from zero to a maximum distance Rₘ) and a range of viewing angles (as shown, from θₘ to −θₘ) are defined with respect to the surface of billboard 10 and comprise the viewing envelope. As shown, the total viewing envelope is defined as a cylindrical sector, i.e., a volume described by cylindrical coordinates r, θ, z, with the z-axis lying within the billboard surface; alternatively, the viewing envelope can be defined using spherical coordinates r, θ, φ, with the origin lying within the billboard surface. Other ways of defining the ranges of distance and viewing angle can also be used if desired and are contemplated as being included within the scope of the present invention.

Automobile 12 in which a human viewer-is carried approaches billboard 10. The viewing angle θ between the human viewer and the billboard 10 is within the viewing envelope (being less than θₘ), but the range Rᵥ from the human viewer to the billboard 10 exceeds the maximum range Rₘ, and thus is outside the viewing envelope. Thus, as perceived by the human viewer, the surface of billboard 10 remains blank (FIG. 1b), with no image being displayed on the human viewer's visual display device, here HUD 14 (FIG. 1c), which in particular embodiments includes a transparent element upon which the appropriate display is projected. In FIG. 2a, the automobile 12 enters the viewing envelope, with Rᵥ and θᵥ now both within the viewing envelope. Accordingly, a virtual image 16, for example an advertisement portraying a female model driving a convertible automobile, is now provided to the viewer by means of the visual display device 14 (see FIGS. 2b-c). In FIG. 3a, the range Rᵥ is still less than the maximum range Rₘ, but the viewing angle θᵥ now exceeds the maximum viewing angle θₘ, and thus lies outside the viewing envelope. The billboard now appears blank again, and the virtual image is no longer provided to the human viewer via the visual display device 14 (see FIGS. 3b-c).

The human viewer, in more specific embodiments, is a member of the organization, discussed above, that maintains the central site and provides the visual images. By virtue of being a member in the organization, the human viewer can, in particular embodiments, specify the nature of the visual information that is provided via the visual display device. The human viewer can select one or more specific goods and/or services for which the display of visual information is requested, and can also specify one or more advertisement formats such as text, still images, video images and/or combinations thereof, in which the visual information is to be presented. For example, a male organization member can select automobiles, more specifically convertible automobiles, as the goods for which visual information is requested, and can also specify that only advertisements containing still or video images-depicting topless female models driving convertible sports cars are desired. Thus, any advertising regime that appeals to the member can be specified.

Further developments of the foregoing exemplary embodiments include age-verification mechanisms to ensure that any display provided to the human viewer is age-appropriate. Thus, the organization, in such embodiments, requires proof that the member is a legal adult before affording the member selections of advertisements that include adult content, such as the aforementioned topless female models. In the same vein, additional embodiments provide ratings for the various displays of visual information (similar to movie or television ratings), and allow the member to prevent transmission of visual information whose ratings are deemed inappropriate or undesirable. With respect to the preceding example, a member could, conversely, reject advertisements featuring nudity or other adult content.

In modifications of the foregoing method, the visual information can be accompanied by audio information, for example a vocal prompt advising the human viewer that visual information is available for viewing.

The foregoing embodiment assumes that the human viewer is actually looking at the surface 10 and thus perceives a virtual image defined on the surface 10. According to other more specific embodiments, the visual display device 14 includes means 18 for determining whether the human viewer is actually looking at the surface 10. Such means can include, for example, an infrared device that determines the direction of the human viewer's eyes, an inertial device that determines whether the visual display device 14 is rotated in a specific direction, or the like. In such embodiments, when it is determined that the human viewer is actually directing attention toward the billboard and perceiving the virtual image, a premium can be provided to the human viewer as a reward for viewing the virtual image. The orientation of the human viewer's eyes and/or HUD is provided to the central site, for example by wireless means. When the orientation is such that the human viewer properly perceives the virtual image defined on the billboard 10, a premium, such as a monetary payment, a discount coupon for a good or service, or the like, is credited to an amount belonging to the human viewer.

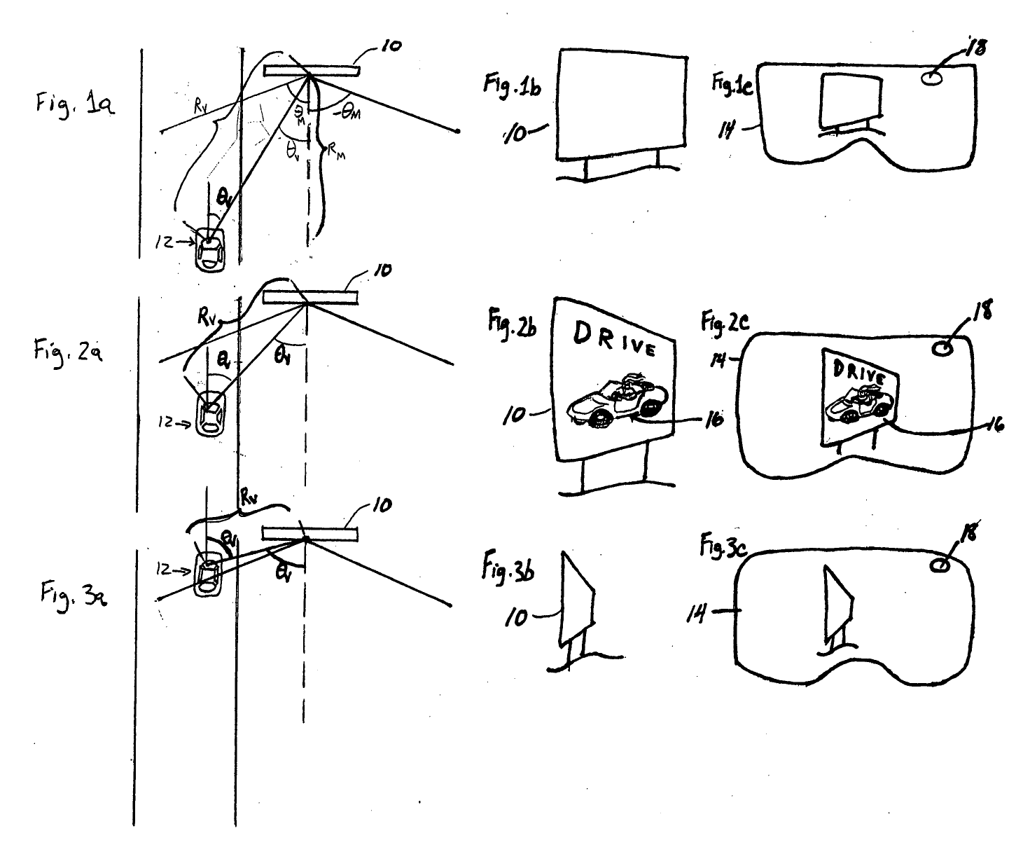

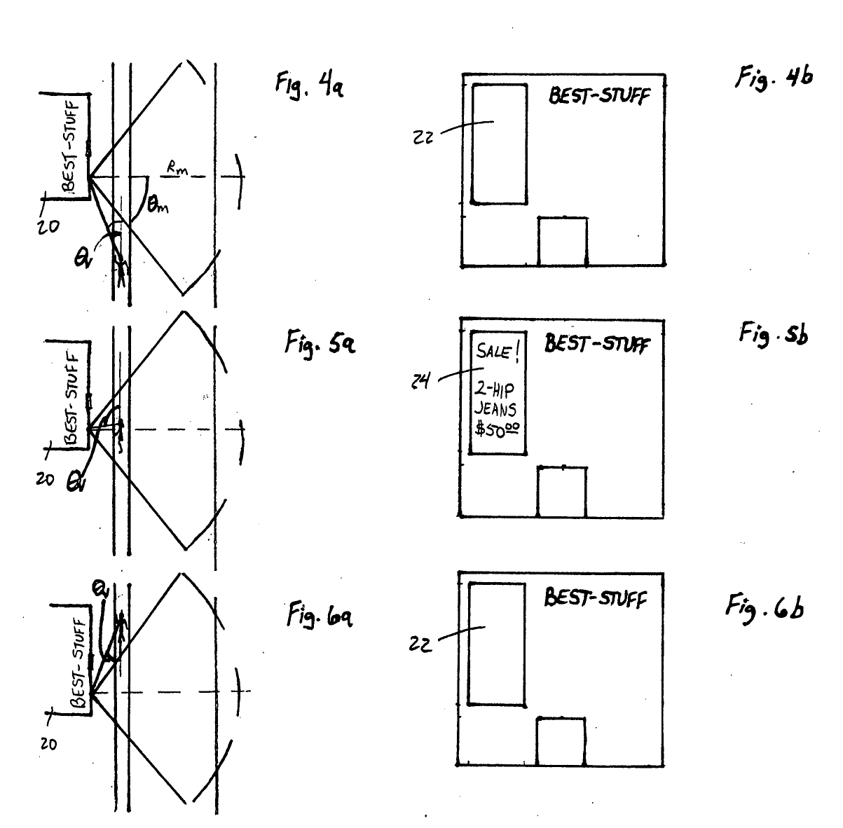

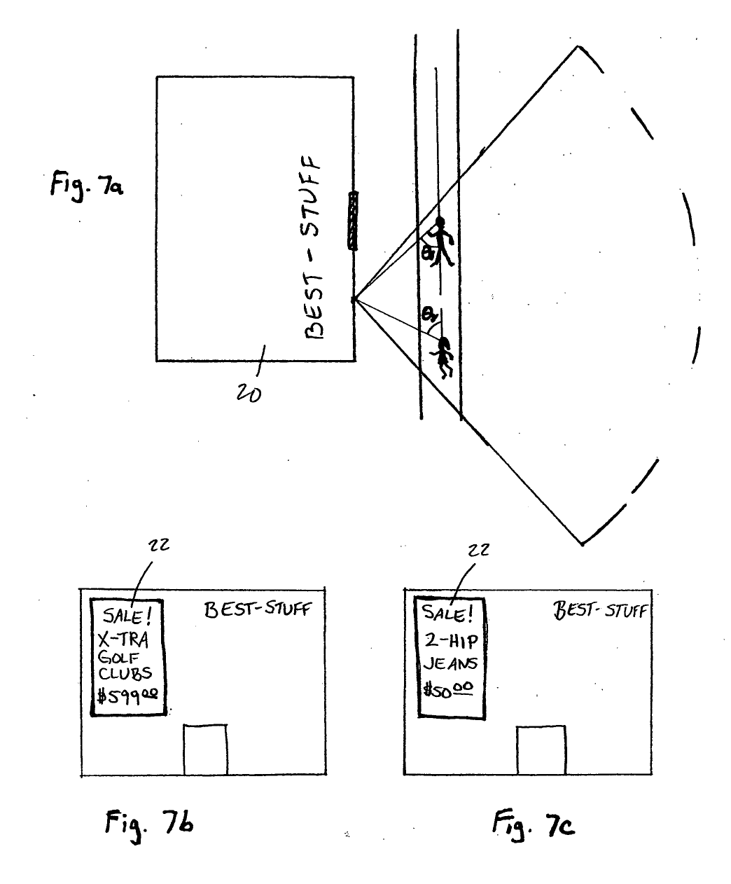

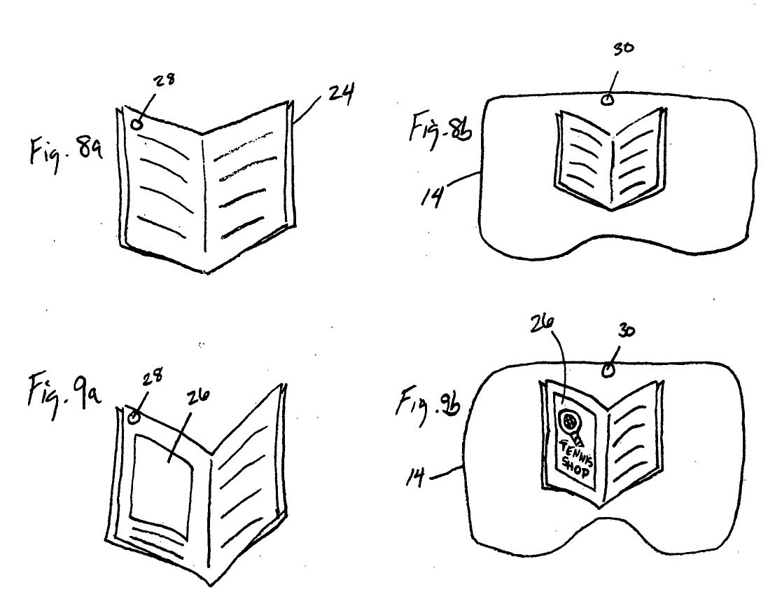

FIGS. 4a-6b illustrate another embodiment of a method according to the invention. A building 20, for example a department store, has a front wall having defined thereon a blank space 22. A human viewer equipped with an HUD or other visual display device approaches the building 20 on foot in FIG. 4a, but is outside the viewing envelope. When the human viewer views blank space 22, she perceives only the blank space; no virtual image appears to be defined thereon (FIG. 4b). In FIG. 5a, the viewer has entered the viewing envelope, and perceives a virtual image of an advertisement appearing in blank space 22 when she views the space through her visual display device (FIG. 5b). Finally, in FIG. 6a the human viewer leaves the viewing envelope, and again perceives only the blank space 22 when she directs her attention to the wall of building 20 in which the blank space is defined.

Multiple human viewers can view the same surface according to further embodiments of the invention, and each viewer can further be provided with a virtual image according to a personalized advertising regime. Thus in FIG. 7a, two human viewers are within the viewing envelope associated with blank space 22 of building 20. A first human viewer perceives a virtual image depicting an advertisement for a product: previously selected by him (FIG. 7b), while a second human viewer perceives a virtual image depicting an advertisement for a different product previously selected by her (FIG. 7c).

As discussed above, a human viewer, especially a human viewer who is a member of an organization that provides visual information according to methods of the present invention, can specify the advertising regime for display via the visual display device. Additional customizations of the visual displays are also possible. Thus, a human viewer who desires to view advertising and other information pertaining to restaurants can specify, via his or her membership in the organization (e.g., by accessing a web site maintained by the organization), provision of visual information describing the types of cuisine, the calories in each menu item, dietary limitations such as meatless meals, kosher meals and the like, etc. A shopper who desires information on sales of a particular item of clothing can request provision of visual information pertaining only to the sales of shorts, dresses, shoes, etc. A human viewer can specify that only video or audio-video advertisements for movies be provided. Any good or service for which visual information can be provided can likewise be selected by the human viewer.

In addition to providing visual information pertaining to preselected goods and/or services, further embodiments of the inventive method provide visual information associated with the human viewer's listening or web-surfing habits. According to such embodiments, when the human user accesses a network, such as the Internet, and views one or more web sites associated with specific goods and/or services, the central site can be notified. The central site then adds one or more advertisements or other visual information pertaining to the specific goods and/or services to the inventory of visual information available for provision to the human viewer. Similarly, when a human viewer listens to a radio station that advertises one or more goods and/or services, or views a broadcast, satellite or cable channel that advertises such goods and/or services, the central site can be so notified. Thus for example, a human viewer could access a web site associated with golfing products. The central site is notified of the human viewer's access to this site (e.g., immediately, by transmission of a suitable notification at a later time, by means of a cookie or other application, etc.), and then adds one or more advertisements pertaining to golfing products to the inventory of visual information that is provided to the human viewer upon his entry into a viewing envelope of a surface such as a billboard, according to methods of the present: invention.

The foregoing embodiments have dealt primarily with commercially-oriented visual information such as advertisements. In additional embodiments of the inventive method, public service announcements can also be provided to the human viewer. In some embodiments, the human viewer can authorize provision of such notices. In other embodiments, public notices are provided automatically, with no need for viewer authorization. Thus, emergency notices, evacuation orders, severe weather alerts, Amber alerts, and the like can be provided to a human viewer via the visual display device worn by or associated with the human viewer. Such public notices can also pre-empt any commercial advertisements or other visual information that may currently be provided to the human viewer.

Visual information can be provided to a human viewer of a book, magazine or other hand-held object as well as to viewers of billboards, truck-trailers or other large, immobile or mobile surfaces. FIGS. 8a-9b illustrate a system and method for providing visual information to a human viewer wearing a visual device such as an HUD, using a magazine that comprises at least one surface upon which the human viewer perceives a visual image. Magazine 24 includes a plurality of pages, on at least one of which a blank surface 26 is defined. Each page includes identification means 28 for identifying the surface, for example, the magazine title, issue number or date, page number, etc. Identification means 28 can be, in various embodiments, an embedded microchip, a symbol which is machine-readable, etc. The human viewer reading the magazine wears a HUD 14 including recognition means 30 for recognizing the page of the magazine which the human viewer is presently viewing. Such recognition means 30 can include, for example, an embedded microchip which reads information contained in a microchip employed as identification means 28, a miniature camera provided with pattern-recognition software that recognizes a symbol include in identification means 28, etc. HUD 14 typically is also in communication with the central site maintained by the organization, beneficially via wireless means.

In FIG. 8a, the human viewer views a page of magazine 24 which includes only text. The human viewer thus views the text of the magazine through the worn HUD 14 (FIG. 8b). In FIG. 9a, the human viewer views another page of magazine 24 which includes a blank space 26. The page is identified via identification means 28 and recognition means 30, and the central site then provides visual information to be displayed to the human viewer as a virtual image by means of HUD 14. Thus, the human viewer perceives a virtual image (as illustrated, an advertisement for a tennis shop) defined in blank space 26.

In further modifications of the foregoing system and method, the magazine itself can include storage means, such as an embedded microchip, containing an inventory of advertisements and/or other visual information. In such embodiments, the magazine itself provides visual information to the human viewer when an appropriate blank space 26 is viewed. More specific embodiments enable the embedded microchip to provide only visual information which the human viewer desires to view. In such embodiments, the human viewer's HUD 14 further comprises selection means, such as an embedded microchip with wireless transmission means, for communicating with the microchip embedded within the magazine and specifying the types of visual information the human viewer desires to receive. Thus, the microchip embedded within the magazine can be instructed to provide visual information pertaining to, e.g., sporting goods, movies, travel accommodations, etc. Different human viewers can provide different instructions to the magazine's embedded microchip via their individual HUD's or other communications devices.

If desired, the human viewer can be provided with a premium for viewing the visual information, in a manner similar to that previously described.

Visual information to be provided to the human viewer as a virtual image on a billboard 10, building 20 or the like, as mentioned above, can also be provided using information storage and transmission devices attached to such surfaces or located adjacent such surfaces. Rather than relaying the information from the central site to the viewer, the information storage and transmission devices interact with a human viewer's HUD 14 or other communication device in a manner similar to the magazine embodiment described above. Here, the human viewer's entry into the viewing envelope is detected in an appropriate manner, and the information storage and transmission devices (which can be part of a single device or separate devices), in cooperation with the viewer's HUD 14 or other communication device, provide selected visual information to the human viewer.

Embodiments have been described in which visual information is provided to the human viewer and perceived as a virtual image projected on the surface of an inanimate object such as a billboard or a portion of a wall of a structure. The inventive method is also suitable for use when the surface to be employed is formed by an item, such as an article of clothing, a mask or the like, worn by a human performer. One or more human viewers can view a performance in which performers wear costumes, masks or other items that include, e.g., blank or blue surfaces. By determining the location of each human viewer with respect to one or more performers, and thus the distance and angle between the human viewer(s) and the performer(s), visual information can be provided to each human viewer in a manner similar to that described above. In some embodiments, the visual information can comprise images of various costumes, so that each human viewer perceives the performer(s) to wear different costumes. In other embodiments, the visual information can comprise images of human faces, so that each human viewer perceives the performer(s) to have different facial features.

Conversely, a plurality of performers can wear visual display devices, in further embodiments of the inventive method, and view a surface upon which virtual images of text, musical scores, etc. are displayed. Each individual performer can be provided with different visual information if desired.

What is claimed is:

1. A method of providing visual information to a human viewer, the method comprising the steps of:
a) defining a range of distances from a surface and a range of viewing angles with respect to the surface,
b) determining the location and viewing angle of a human viewer with respect to the surface, and
c) providing a virtual image to the human viewer via a visual display device worn by the human viewer when the location and viewing angle of the human viewer with respect to the surface is determined to be within the range of distances and viewing angles selected in step a), such that the virtual image is perceived to be defined on the surface by the human viewer.

2. The method of claim 1 wherein the surface is selected from the group consisting of a billboard, a wall, a static display and a hand-held item.

3. The method of claims 2 wherein the hand-held item is selected from the group consisting of a book, a magazine, a newspaper and a menu.

4. The method of claim 2 wherein at least a portion of the surface is blank.

5. The method of claim 2 wherein at least a portion of the surface is a blue surface.

6. The method of claim 1 wherein in step b) the location and viewing angle of the human viewer with respect to the surface are determined using the GPS coordinates of the human viewer and the surface.

7. The method of claim 1 wherein in step c) the visual display device comprises a heads-up display.

8. The method of claim 1 wherein in step c) the virtual image provided to the human viewer comprises an image selected from the group consisting of an advertisement, a menu and a public notice.

9. The method of claim 1 wherein in step c) the virtual image is provided to the human viewer via wireless transmission means.

10. The method of claim 1 wherein the human viewer is a member of an organization and the virtual image is provided to the human viewer from a central site affiliated with the organization.

11. The method of claim 10 wherein prior to step c) the human viewer selects at least one good or service for which the human viewer requests the provision of a virtual image.

12. The method of claim 10 wherein prior to step c) the human viewer selects at least one advertisement format in which the virtual image is to be displayed.

13. The method of claim 12 wherein the advertisement format is selected from the group consisting of text, still images, video images and combinations thereof.

14. The method of claim 13 wherein the advertisement format comprises images of human models.

15. The method of claim 11 wherein the virtual image comprises an image selected from the group consisting of an advertisement and a menu.

16. The method of claim 10 wherein prior to step c) the human viewer selects at least one event for which the human viewer requests the provision of a virtual image.

17. The method of claim 16 wherein the event is selected from the group consisting of a sale, a sporting event, a movie and a live performance.

18. The method of claim 17 wherein the event is a sale and wherein the human viewer selects at least one good or service that is the subject of the sale.

19. The method of claim 1 wherein the virtual image is accompanied by an audio stream.

20. The method of claim 19 wherein the audio stream comprises a verbal advisory.

21. The method of claim 15 wherein a premium is provided to the human viewer when the human viewer views the virtual image.

22. The method of claim 1 wherein the surface comprises at least a portion of a surface of a vehicle.

23. The method of claim 22 wherein the vehicle is in motion.

24. The method of claim 1 wherein the surface comprises an article of clothing worn by a human performer.

25. The method of claim 24 wherein the virtual image comprises an image of a costume.

26. The method of claim 24 wherein the article of clothing is a mask and wherein the virtual image comprises an image of a human face.

27. A method of receiving visual information from a provider, the visual information being transmitted to a human viewer as a virtual image, the human viewer wearing a visual display device enabling viewing of a virtual image, the method comprising the steps of:
a) providing the location of a human viewer to a central site with which a provider is associated,
b) determining the distance and the viewing angle between the human viewer and a surface associated with the provider, and
c) receiving a virtual image from the provider via a visual display device worn by the human viewer enabling viewing of the virtual image when the distance and viewing angle between the human viewer and the surface is determined to be within a range of distances and viewing angles specified by the provider.

28. The method of claim 27 wherein in step a) the location of the human viewer is determined using the GPS coordinates of the human viewer.

29. The method of claim 27 wherein the human viewer is a member of an organization and the central site is associated with the organization.

30. The method of claim 30 wherein prior to step a) the human viewer selects at least one good or service for which the human viewer requests the provision of a virtual image.

31. The method of claim 29 wherein prior to step a) the human viewer selects at least one advertisement format in which the virtual image is to be displayed.

32. The method of claim 29 wherein prior to step a) the human viewer selects at least one event for which the human viewer requests the provision of a virtual image.

33. A system for providing visual information to a human viewer, the system comprising:
a) means for determining the location and viewing angle of a human viewer with respect to a surface,
b) a visual display device worn by the human viewer, and
c) means for providing a virtual image to the human viewer via the visual display device when the location and viewing angle of the human viewer with respect to the surface is determined to be within a preselected range of distances and viewing angles with respect to the surface, such that the virtual image is perceived to be defined on the surface by the human viewer.

34. The system of claim 33 wherein an item adapted to be held by the human viewer comprises the surface.

35. The system of claim 34 wherein the item is selected from the group consisting of a book, a magazine and a newspaper.
